(19) United States
(12) Patent Application Publication
(10) Pub. No.: US 2025/0383863 A1
(43) Pub. Date: Dec. 18, 2025

(54) METHOD FOR UPDATING A UNIT OF A WIND FARM AS WELL AS SYSTEM THEREOF

(71) Applicant: Wobben Properties GmbH, Aurich (DE)

(72) Inventor: Alexander POOLMANN, Ihlow (DE)

(21) Appl. No.: 19/242,664

(22) Filed: Jun. 18, 2025

(30) Foreign Application Priority Data
Jun. 18, 2024 (EP) 24182875.5

(51) Int. Cl. G06F 8/65; F03D 7/04; F03D 80/50

(52) U.S. Cl. CPC G06F 8/65; F03D 7/048; F03D 80/50

(57) ABSTRACT

Aspects of the present disclosure relate to a method for updating at least one unit in a wind turbine of at least one of several wind farms, with an updating device arranged outside of the wind farm and configured to establish a data connection with the several wind farms. The method includes providing a database that includes entries for several units of the several wind farms with software configured to be updated; receiving a selection of at least one unit of the several units from the database; assembling a packet for the wind farm, the packet including the unit selected, and at least one software update file; transferring the packet to the wind farm; outputting information after completion of the transfer; receiving an approval for performing the update; performing the update; receiving a confirmation of a successful update; and storing an indication of the successful update in the database.

### TECHNICAL FIELD

The present disclosure relates to a method for updating at least one unit, in particular a wind turbine, of at least one of several wind farms. In addition, the present disclosure relates to a system for updating the unit.

### BACKGROUND

Wind turbines are generally known, and convert kinetic energy from the wind into electrical energy. The electrical energy is fed into an electrical supply network. The wind turbine itself and the entire conversion process, from extracting the kinetic energy from the wind to feeding the electrical energy into the network, presents the wind turbine with complex tasks. In order to perform these tasks, a plurality of different electronic control units are provided, for example which each control groups of actuators as a function of sensor inputs and control signals.

For example, the control units generate output data for activating actuators as a function of input data from sensors or data from other control units. The output data are generated with a software of the control unit by processing the input data. Because requirements frequently change during the runtime of a wind turbine, and have lately also become increasingly stringent, software operation can frequently not be updated by new parameters, and it becomes necessary to routinely update the software in units of a wind farm, such as wind turbines, a central wind farm computer or even other units of the wind farm, such as energy storage devices.

As the functionality of the wind turbine grows, so too does the number of updatable control units or modules of a unit. For example, updating is also necessary for complying with contracts, for example with an operator of the electrical supply network which a wind farm feeds into. As a result, routine updating becomes essential.

Updating the software of a unit of a wind farm, such as a wind turbine, usually involves a significant intervention in wind turbine operation, in order to set the wind turbine to a safe operating mode. This is because undefinable operating situations must be avoided even given a short-term loss in controllability in the updating process, so as to ensure safety. Since such an intervention can also have an impact on other components of the wind farm or the network, it cannot take place spontaneously, but must rather be planned as precisely as possible.

In addition, such an intervention is usually performed under the observation of a service employee, who performs the update. The service employee must be well trained in updating a unit. For example, the task of the service employee is to recognized which module of the wind turbine can even be updated with a software update, since a new version is available for this purpose. In addition, the service employee must recognize which module must not be updated despite an available software update, for example for complying with the mentioned contracts.

For this reason, a service employee must precisely plan the updating process in advance, for example to have access to the files required for a software update on site, in particular if the wind turbine only has very slow data connections which in part make it nearly impossible to load the files within a reasonable timeframe. If a required software update by a service employee is not possible given such a case of a slow data connection, either a very prolonged use in order to load the software update during this use remains, or the unit to be updated has to be rebooted.

As a result, the problem when updating a software lies in the fact that, on the one hand, only expert personnel can perform an update, so as to consider a plurality of factors during the updating process, such as the mentioned contracts, and on the other, that the updating process must be precisely planned or can potentially last a long time.

### SUMMARY

Therefore, one objective of the present disclosure is to counter the problems in prior art. In particular, a solution is to be found which allows the units of a wind farm to be updated with a current software more quickly and safely. At the very least, however, an alternative solution to prior art is to be proposed.

The present disclosure proposes a method for updating at least one unit of a wind farm according to claim 1.

Accordingly, a method is proposed for updating at least one unit of at least one of several wind farms, wherein the unit in particular is a wind turbine. Alternatively, the unit can be a STATCOM unit, an accumulator or a wind farm controller of the wind farm.

A wind farm according to the present disclosure is preferably a unit comprised of several wind turbines, which feed their electrical energy into a network, such as a supply network, at a shared feed point. A higher-level control entity of the wind farm, which is referred to as a wind farm controller, is preferably allocated to the wind turbines of a wind farm, wherein the wind farm controller is preferably likewise arranged locally in combination with the allocated wind turbines, i.e., in the wind farm. The wind farm especially preferably has an internal data network, wherein the internal data network allows an exchange of data between the wind farm controller and the individual wind turbines of the wind farm. An external data connection is preferably also provided, which connects the wind farm controller of a wind farm with an external data network that is external to the wind farm, i.e., lies outside of the wind farm.

According to a preferred alternative, several or all wind turbines of the wind farm are preferably connectable or connected with an external data network lying outside of the wind farm, preferably via their own external data connection, so as to exchange data across the wind farm, for example. In this case, a wind farm controller is still present nonetheless in order to coordinate the wind turbines via an internal data connection. However, it is not absolutely necessary for the wind farm controller to be present in a case where the wind turbines are each connected with an external network via an external data connection.

According to the method, updating takes places with an updating device, which is arranged outside of the wind farm and connected with one or several units of the wind farm via an external data connection.

The updating device comprises a database. The database comprises entries for several units of several wind farms, the software of which can be updated by the updating device. This database is provided in the updating device. Furthermore, a selection is further received by the updating device, wherein the selection comprises at least one unit from the database. The selection thus displays at least one unit. For example, the selection is received after a user has selected one or several units and confirmed this selection. As a result, the selection displays the selected units. Furthermore, the updating device is set up to assemble a packet for a wind farm. As a result, the updating device assembles at least one packet for the wind farm, which comprises the unit or the units of the selection. As a result, a packet is prepared in the updating device for precisely the unit or units of the selection assembled for precisely the wind farm that comprises the unit or units.

The packet here comprises at least one software updating file or, in a case where several software updating files are available for a unit, for example for several components or modules of the unit, several software updating files for each of the respective modules. The packet is thereupon transferred by the updating device from the updating device into the wind farm with the unit of the selection. The updating device is thus set up to establish a data connection with the wind farm and transfer the packet assembled for a predefined wind farm to the corresponding wind farm.

After the transfer, a piece of information is output by the updating device indicating the completion of the transfer. For example, the information can be output by the updating device to a user, e.g., by sending a push message, preferably as an e-mail or a short message to a mobile phone. Alternatively or additionally, the information can be output by just showing a display with the updating device.

This is followed by waiting until an approval of the update has been received, i.e., an execution of the software update file, preferably on the or by the allocated unit or control unit. That is to say, updating with the software updating file is not performed instantaneously; rather, one initially waits until the approval has been received. Only after the approval has been received is the update performed. For example, the approval can involve the release of the software update by a service technician, e.g., via an entry on the unit. The update is then preferably performed, meaning that the software of the unit or one or several components of the unit is adjusted or updated with the respective software update files.

After the unit has been updated with the software update file or all software update files of a packet, the updating device receives a confirmation of a successful update, and stores an indicator that displays the successful update in the database. Therefore, the indicator comprises an identifier of the component of the unit for the unit, for example, along with a version number of the software that was received with the software update file. Therefore, the database also preferably always comprises all current version numbers of each updatable software of the updatable units.

The updating device, which is located outside of the wind farm and can be used to update a plurality of wind farms, specifically their units, provides a centralized facility that initially makes it possible to automatedly compile the software update files available for the respective unit. A service employee thus no longer needs to keep software update files available at the location of the unit, and transfer or load them. A shortened use at the unit location is thus possible, since the software is already present in the unit or at least in the wind farm, and a service employee only has to start the updating process by granting approval, for example. Alternatively, approval can even be granted remotely, so that a service employee need no longer be on site. However, the required approval is preferably one received by the unit to be updated, i.e., the unit of the selection, or by the wind farm in which the unit is located, directly at the location of the unit or the wind farm, so as to ensure that the unit is in a safe condition, in particular in cases involving a wind turbine.

The database in which the indicator for a unit notes whether an update was successful can thus be used while receiving or preparing new software update files to verify whether this new software update file is necessary or possible for a unit. If the latter is necessary or possible, it is preferably added to the packet accordingly if the unit was selected.

As a consequence, the method also involves providing and informing or sending an as yet still unknown software update file to the updating device. Alternatively or additionally, the method involves receiving a software update file as yet still unknown to the updating device, or at least receiving a piece of information about the provision of a software update file as yet still unknown to the updating device. Furthermore, preferably once the information about the provision of a software update file as yet still unknown to the updating device has been received or the as yet still unknown software update file itself has been received, units updated with the database are then acquired and information about the updatability of the acquired updatable units are output, for example to operators, service employees or other offices. The selection is then awaited.

This also reduces the susceptibility to errors, for example as the result of false or unauthorized software updates.

According to one example, in a case where the selection involves one or several units of several different wind farms, a corresponding packet is assembled for each respective wind farm. A packet is thus generated specific to a wind farm, and can only be used for the provided wind farm. The corresponding packet is then transferred to the respective wind farm. For this reason, each packet preferably comprises wind farm-specific data, for example a wind farm identifier.

Each wind farm thus receives a packet individually provided for the unit or units of the selection. According to another alternative example, in a case where the selection involves one or several units of several identical or different wind farms, a separate packet is assembled for each unit of the selection, which respectively comprises the one or several software update files available for the respective unit of the selection. The packets are then each transferred to the corresponding unit.

According to another example, each entry into the database allocated to a respective unit comprises a configuration of the unit. For example, a configuration comprises at least one list, which comprises or displays all components, or at least all updatable components of the unit. Additionally or alternatively, each entry into the database comprises at least one parameter of the unit. Parameters here denote values that are prescribed for a specific software and have an influence on the program sequence. Therefore, the program is set by parameters.

The method further involves retrieving the configuration and inserting the software update files for at least one unit of the selection, which based on their configuration are suitable or prepared for the unit. Even if the configuration indicates a plurality of updatable components, only available and preferably approved software update files are inserted into the packet. In addition, preferably only software update files which update a software of the unit to a higher version number are inserted into the packet.

Alternatively or additionally, at least one parameter of the unit is inserted into the packet, and the unit is parameterized with the parameters of the packet, especially preferably after the unit has been updated. The configuration thus makes it possible to precisely define which available and approved software updates for a selected unit be inserted into the packet. Providing additional parameters in the packet enables a reparameterization after the update.

According to another example, at least one software update file is received by the updating device before a selection is received. Alternatively, at least one software update file is provided for the updating device or the updating device is informed about a newly provided software update file. For example, the provision involves informing the updating device about a newly available software update file. In the ensuing step, the updating device is used to determine which of the units in the database can be updated with the software update file that was received or provided. Information displaying several or all determined units are thereupon output, and several or all determined units are provided as available units for the selection.

The updating device thus preferably automatically recognizes as soon as a new software update file is provided, and outputs information to inform users, operators or service employees, for example, about newly available software update files. A user or service employee can thereupon select the units accordingly. Therefore, a user, operator or service employee need not constantly check whether new software update files are available, but is rather informed by the information, thereby enabling a targeted selection of updatable units.

According to another example, after the reception or provision of at least one new software update file, in particular a software update file of a specific type or a specific version, a predefined maximum number, for example contained in the database or in the software update file itself, is determined for the new software update file. For example, the maximum number corresponds to a number of 10, 100 or 1000. This maximum number is preferably increased up to a total number as a function of a time progression. The total number corresponds to all units that can be updated with the updating device using the new software update file. For example, the increase with time progression corresponds to the increase by a specific value, such as 10, per time interval, for example per week or month. Furthermore, only information about the newly available software update file for a number of units corresponding to the maximum number are output, and these units are provided as selectable units. For example, the time progression corresponds to an increase in the maximum number by a factor of 10 per week or per month.

A software update file that might still have errors despite careful development can in this way be prevented from automatically being used in all units right away, with all units updatable with the updating device rather being successively updated. This prevents a complete failure of all units that can be updated with the updating device given a defective software.

According to another example, after the reception or provision of at least one new software update file, in particular a software update file of a specific type or a specific version, a predefined maximum number, for example contained in the database or in the software update file itself, is determined for the new software update file. For example, the maximum number corresponds to a number of 10, 100 or 1000. Alternatively or additionally to an increase in the maximum number as a function of a time progression, the number of transferred packets and/or performed updates is acquired by the updating device, and the maximum number is increased as a function of the acquired number.

A software update file is thus only released for installation for a specific number of units, and a continuous rollout specific to the software update file takes places as a function of the time progression and/or the number of already performed updates.

According to another example, the packet(s) is/are assembled as a function of a bandwidth and/or a length of an internal data connection of the wind farm, in which the unit allocated to the packet is arranged.

In other words, bandwidths or lengths of internal data connections with which data are exchanged within the wind farm are stored in the database for the wind farm allocated to the units. Assembly then takes place as a function of a bandwidth and/or a length of the internal data connection. Assembly preferably takes place in such a way that the respective packet for the wind farm is assembled in several partial packets with a predefined maximum data size. Therefore, the number of partial packets or the maximum data size per partial packet depends on the bandwidth or length.

This ensures that units within an older wind farm having an internal data connection with only a slight bandwidth can be updated. This is because large data quantities are transferred in the form of the partial packets with a maximum data size. For example, such older wind farms comprise a serial data connection between a wind farm controller and a wind turbine, the limitation of which would otherwise be faulty in execution during the transfer of packets with excessively large data sizes.

Software update files for wind farms with internal data connections having a low bandwidth are thus likewise possible.

According to another example, contract data for each unit or each wind farm allocated to the unit are stored in the database. After a new software update file has been received or provided, a check is for this reason performed in the database to see whether the new software update file for corresponding units is usable or allowed for updating purposes taking into account the stored contract data. Only in the event that the stored contract data for the unit or the wind farm belonging to the unit permit an update is the software update file released, for example by outputting information indicating an available software update file for the unit, and/or by providing the unit as a selectable unit.

A service employee thus does not have to have any knowledge about contact data that might be relevant for whether an available software update file can be executed on a specific unit or not.

According to another example, the process of waiting for the approval to be received and/or the update to be made is performed by the unit of the selection or another unit of the wind farm in which the unit of selection is arranged. Therefore, in one example, a service employee grants the approval at the site of the unit, for example by virtue of finding and selecting a suitable timeframe and/or checking a status of the wind turbine. Additionally or alternatively, the update is likewise performed by the unit, for example the wind turbine itself, or by another unit, such as a wind farm controller, after the approval has been received.

In this way, it can be ensured that an onsite check has to take place before the update is performed. As a result, unsafe operating states in which a wind turbine might potentially get into an undefined state are avoided.

According to another example, a packet comprises several different software update files for several corresponding components of a unit, wherein each of the components of a unit is updated with the corresponding software update file.

Several components of a unit can thus be updated simultaneously.

According to another example, after the approval has been received, the unit is switched into a predefined safe state, or a check is performed to see whether the unit is already in a predefined safe state. The update is only performed if the unit has the safe state.

The unit can thus be prevented from accepting an undefined state during an update, which could pose a risk of damage to the unit. This makes it possible to avoid damage or malfunction.

According to another example, after a unit has been selected from the database, all components of the unit can be acquired with the updating device, and the packet for the unit is generated in such a way that all available and, in particular contractually permitted, software updates are provided for the components of the unit in the packet.

According to another example, the process of waiting for an approval involves waiting for the entry of a component of the unit of the wind farm or the updating device. The approval preferably also comprises a prescribed timeframe for the update. The update is then performed in the prescribed timeframe. For example, suitable timeframes for an update are determined as timeframes within which only a weak wind blows or little energy demand exists based upon forecasts.

In addition, the present disclosure relates to a system that is set up to implement the method according to one of the aforementioned examples.

According to an example of the system, the system comprises an updating device that is set up to provide a database, receive a selection, assemble a packet, transfer the packet and receive a confirmation of a successful update.

According to another example, the system comprises one or several wind farms each having several units, in particular wind turbines.

### BRIEF DESCRIPTION OF THE DRAWINGS

Additional examples arise based on the exemplary embodiments explained in more detail on the figures. Shown here on:

FIG. 1 is a wind turbine,

FIG. 2 is an updating device with several wind farms, and

FIG. 3 is the sequence for an exemplary embodiment of the method.

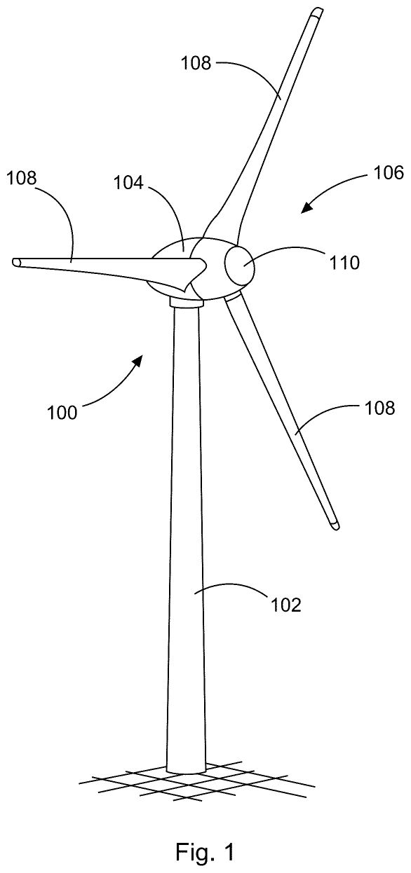

FIG. 1 shows a schematic illustration of a wind turbine 100 according to the present disclosure.

### DETAILED DESCRIPTION

The wind turbine 100 has a tower 102 and a nacelle 104 on the tower 102. An aerodynamic rotor 106 with three rotor blades 108 and a spinner 110 is provided on the nacelle 104. During operation of the wind turbine 100, the aerodynamic rotor 106 is made to rotate by the wind, and thus also turns an electrodynamic rotor or runner of a wind turbine generator, which is coupled directly or indirectly with the aerodynamic rotor 106. The electric wind turbine generator is arranged in the nacelle 104, and generates electrical energy. The pitch angles of the rotor blades 108 can be changed by pitch motors on the rotor blade roots of the respective rotor blades 108.

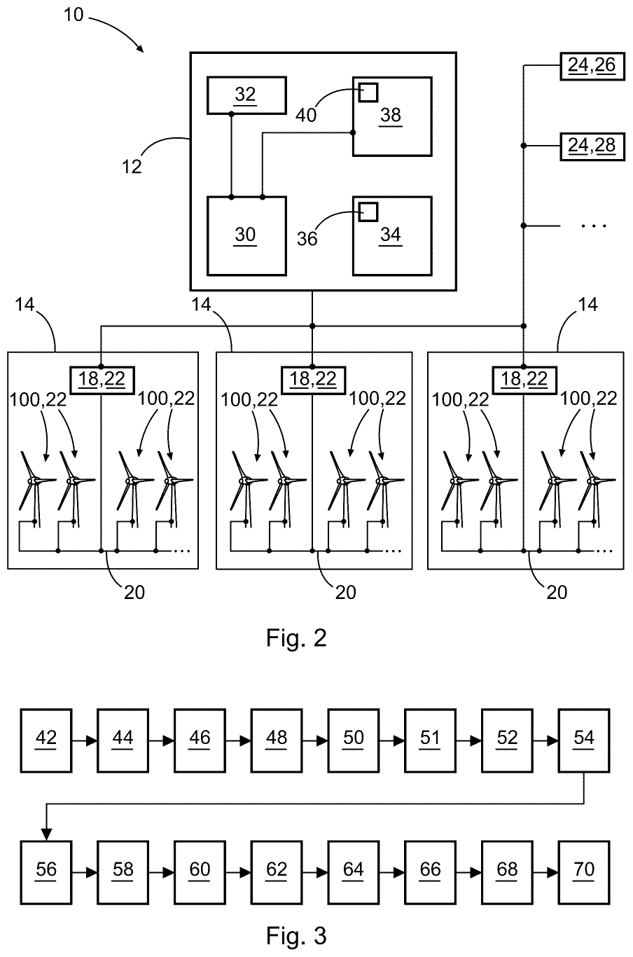

FIG. 2 shows a system 10 according to an example of the present disclosure. The system 10 comprises an updating device 12 and several wind farms 14, which are connected via an external data network 16 with the updating device 12 for exchanging data. Each of the wind farms 14 comprises a wind farm controller 18 and several wind turbines 100, wherein the wind turbines 100 are connected via an internal data network 20 with the wind farm controller 18 of the corresponding wind farm 14. The wind farm controller 18 in turn establishes a connection between the internal data network 20 and the external data network 16. The wind turbines 100 and the wind farm controller 18 can also be referred to as units 22 of the respective wind farm 14.

The external data network 16, which corresponds to the internet, for example, is connected with additional computing units 24, for example which are to be allocated to an operator of one or several of the wind farms 14, and hence also be referred to as operator PC's 26. The computing units 24 can also be allocated to service employees, and are therefore to be designated as service PC's 28. The updating device 12 comprises a processor unit 30, which can execute several or all steps of the method according to the present disclosure. For example, the processor unit 30 is connected with a display 32, so as to indicate various states of the updating device 12 or output information. The display 32 can also be arranged outside of the updating device 12, and consist of one of the computing units 24, for example. The processor unit 30 is connected with a database 34 of the updating device 12, so as to retrieve, generate or modify entries 36 in the database 34. Additionally shown is a software memory 38 in the updating device 12, which can be used to provide software update files 40 for the units 22 of the wind farm 14.

FIG. 3 shows the sequence of an exemplary embodiment of the method. In step 42, the updating device 12 is initially provided with a piece of information about a new software update file 40. For example, this information indicates that a software update file 40 as yet still unknown to the updating device 12 was provided in a software memory 38. The software memory 38 can be part of the updating device 12, or lie outside of the updating device 12.

In step 44, the updating device 12 checks the units 22 for which the new software update file 40 can be used. In step 46, operators or service employes are informed about an available software update file 40 for specific units, either via a display 32 or via messages or information to computing units 24. In step 48, the acquired units 22 are additionally provided as selectable units 22 in the updating device 12. For example, an operator or service employee can then select units 22 that are selectable via the computing units 24 in step 50.

In step 51, the updating device 12 thus receives a selection that comprises one or several selected units 22. In step 52, a packet is provided for each unit 22 or for several units 22 of a wind farm 14, and comprises one or several of the software update files 40. In step 54, the or each of the packets is transferred to the provided unit 22 or the provided units 22. In step 56, a response is received from the unit 22 or the wind farm 14, indicating that the packet is present at the unit 22, meaning that the transfer 54 was successful. Step 58 then involves waiting for an approval to perform the update.

In step 60, a service employee switches the unit 22, for example the wind turbine 100, into a safe state. After a check was performed in step 62 to verify that the wind turbine 100 is in a safe state, the approval is granted in step 64. In step 66, the unit 22 is then updated within the unit 22, and once done, a successfully completed update is reported back to the updating device 12 in step 68. In step 70, a notation is made in the database 34 that the wind turbine 100 was successfully updated.

### REFERENCE LIST

10 System
12 Updating device
14 Wind farms
16 External data network
18 Wind farm controller
20 Internal data network
22 Units
24 Computing units
26 Operator PC
28 Service PC
30 Processor unit
32 Display
34 Database
36 Entries
38 Software memory
40 Software update files
42 Provide information
44 Check software unit
46 Inform operator or service employee
48 Provide units
50 Select units
51 Receive selection
52 Provide packet
54 Transfer packet
56 Receive response
58 Wait for approval
60 Switch unit
62 Check state
64 Grant approval
66 Perform update
68 Report successful completion
70 Note successful update
100 Wind turbine
102 Tower
104 Nacelle
106 Aerodynamic rotor
108 Rotor blades
110 Spinner

1. A method for updating at least one unit in a wind turbine, of at least one of several wind farms, with an updating device arranged outside of the wind farm, wherein the updating device is configured to establish a data connection with the several wind farms, the method comprises:
providing a database that includes entries for several units of the several wind farms, the database having software configured to be updated by the updating device;
receiving a selection of at least one unit of the several units from the database via the updating device;
assembling a packet for the wind farm, the packet including the unit selected via the updating device, and at least one software update file for the unit;
transferring the packet from the updating device to the wind farm;
outputting information after completion of the transfer via the updating device;
receiving an approval for performing the update;
performing the update upon receiving the approval;
receiving a confirmation of a successful update; and
storing an indication of the successful update in the database.

2. The method according to claim 1, wherein if the selection comprises one or several units of several different wind farms, at least one respective corresponding packet is assembled for each of the wind farms, and the corresponding respective packet is transferred to a corresponding one of the wind farms, wherein each packet comprises a respective code for the respective wind farm.

3. The method according to claim 1, wherein
each entry in the database comprises a configuration of the unit associated with the entry, which indicates all or at least all updatable components of the unit,
each entry in the database comprises at least one parameter of the unit associated with to the entry, and
the assembling includes at least one of:
retrieving the configuration and selecting one or several software update files as a function of the configuration for the packet, or
retrieving the parameter and inserting the parameter into the packet.

4. The method according to claim 1, wherein, before a selection is received, the method comprises:
receiving at least one software update file via the updating device or receiving information about a provision of at least one software update file for the updating device,
using the updating device to determine units in the database that can be updated with the updating device and the received software update file,
outputting information that displays several or all of the units, and
providing the several or all of the units as selectable units for the selection.

5. The method according to claim 1, wherein, after at least one new software update file has been received, a maximum number is determined for the new software update file, wherein the maximum number is increased up to a total number as a function of a time progression, and wherein information about the new software update file is output for a number of the units that correspond to the maximum number, and are provided as selectable units.

6. The method according to claim 5, wherein at least one of a number of transferred packets or performed updates are acquired for the new software update file via the updating device, and the maximum number is increased up to the total number as a function of the number of the transferred packets or the performed updates.

7. The method according to claim 1, wherein
a packet is assembled as a function of at least one of a bandwidth or a length of an internal data connection within the respective wind farm in which the unit is arranged,
the packet is assembled in several partial packets with an associated maximum data size, and
at least one of a number of the partial packets or the associated maximum data size is determined as a function of at least one of the bandwidth or the length.

8. The method according to claim 1, wherein contract data for each unit or for each wind farm are stored in the database, and, after a new software update file is received, or at least before the update is performed, a check is performed to determine whether the software update file is usable or authorized for a corresponding unit.

9. The method according to claim 1, wherein an additional unit waits for the approval to be received before performing the update or performs the update.

10. The method according to claim 1, wherein a packet comprises several different software update files for several corresponding components of the unit, and each of the components of the unit is updated with the corresponding software update file.

11. The method according to claim 1, wherein, after the approval has been received, the unit switches to a safe state prior to performing the update.

12. The method according to claim 1, wherein the approval is received within a prescribed timeframe for the update.

13. A system for updating at least one unit of a wind farm, the system comprising:
an updating device arranged outside of the wind farm, wherein the updating device is configured to:
establish a data connection with the wind farm;
provide a database that includes entries for several units of the wind farm, the database having software configured to be updated by the updating device;
receive a selection of at least one unit of the several units from the database;
assemble a packet for the wind farm, the packet including the unit selected via the updating device, and at least one software update file for the unit;
transfer the packet from the updating device to the wind farm;
output information after completion of the transfer via the updating device;
receive an approval for performing the update;
perform the update upon receiving the approval;
receive a confirmation of a successful update; and
store an indication of the successful update in the database.

14. (canceled)

15. The system according to claim 13, wherein the system comprises several wind farms, each of which has several units, wherein the several units include one or more in particular wind turbines.

16. The method of claim 8, further comprising:
outputting the new software update file if the contract data indicates that the update is permitted.
